(19) United States
(12) Patent Application Publication
(10) Pub. No.: US 2010/0057695 A1
(43) Pub. Date: Mar. 4, 2010

(54) POST-PROCESSING SEARCH RESULTS ON A CLIENT COMPUTER

(75) Inventors: Darko Kirovski, Kirkland, WA (US); Renan G. Cattelan, Ipigua (BR)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/361,550

(22) Filed: Jan. 29, 2009

Related U.S. Application Data
(60) Provisional application No. 61/092,605, filed on Aug. 28, 2008.

(51) Int. Cl. G06F 17/30

(52) U.S. Cl. 707/3; 707/E17.108

(57) ABSTRACT

Described is a technology by which a deep query response comprising a large number of URLs is processed at a client-side recipient into a secondary set of search results. A client requests a deep query response (e.g., hundreds of URLs) related to a query, generally in conjunction with a traditional query request/response. As the traditional query response is output for inspection by the user, the client performs deep query processing on the deep query response by fetching files for the deep response URLs, and parsing those files for analyzing their content, e.g., to perform ranking and/or summarizing for a secondary output. Because more files and their content are evaluated and processed in client-side deep query processing, more relevantly ranked and/or summarized content is provided to the user, which may include improved advertising revenue. Queries also may be classified into a query type for use in deep query processing.

### CROSS-REFERENCE TO RELATED APPLICATION

The present application claims priority to U.S. provisional patent application Ser. No. 61/092,605, filed Aug. 28, 2008.

### BACKGROUND

Search engines are typically allowed several tens of milliseconds to respond to a query. Preparing the response typically includes retrieving related pages, ranking them, retrieving related advertisements, and sorting them based upon current bids, all within the allowed time limit.

As a result of such short timing, the quality of results to web-search queries suffers. In general this is because more sophisticated processing of the query cannot be performed within the time limit, even though it likely would yield a more satisfying user experience, both from the perspective of the query results as well as the relevance of displayed advertisements.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which a client performs deep query processing to provide deep search results, in which a deep query and results are typically based on many more times the number of search results provided by a traditional query/response. In general, the deep results are more relevant to a user than a traditional search result provided by a search engine.

In one aspect, a client requests a deep query response (e.g., hundreds of URLs) related to a query. The traditional request/response may also be performed for the same query, such that while the user is inspecting the traditional response search results, deep query processing fetches files (e.g., HTML) corresponding to the URLs, and processes those files into deep search results. For example, analysis may comprises ranking and summarization based on content parsed from the HTML files, which provides more relevant content that tends to more closely match what the user is hoping to get back.

In one aspect, queries are classified based on their type. The type of query is used in the analysis, along with content analysis and possibly other factors (e.g., user preference data) to further improve relevance ranking, e.g., to provide more relevant ranking of links, and/or more relevant advertising.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram showing example components for performing deep query processing on a client computer to provide deep search results.

FIG. 2 is a flow diagram showing example client-side steps taken perform deep query processing to provide deep search results.

FIG. 3 is a representation of processing deep query results and a query, including by query classification, for analysis.

FIG. 4 shows an illustrative example of a computing environment into which various aspects of the present invention may be incorporated.

### DETAILED DESCRIPTION

Various aspects of the technology described herein are directed towards a model for a web search mechanism in which a significant amount of the query/search processing is migrated from a search engine to a requesting client machine. In one example implementation, the search engine replies to a search query Q with a relatively large list of URLs deemed relevant by the server. The client downloads the target HTML files for those URLs, parses them, and understands their content to an extent. Based on each file's content, the client-side process provides a re-ranked and/or summarized list to the user. In this manner, not only are more satisfying search results provided to the client user, but the platform significantly lowers search server workload. This also facilitates a separate revenue stream, in part from more targeted advertisements.

It should be understood that any of the examples set forth herein are only for descriptive purposes, and are non-limiting examples. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and data search and retrieval in general.

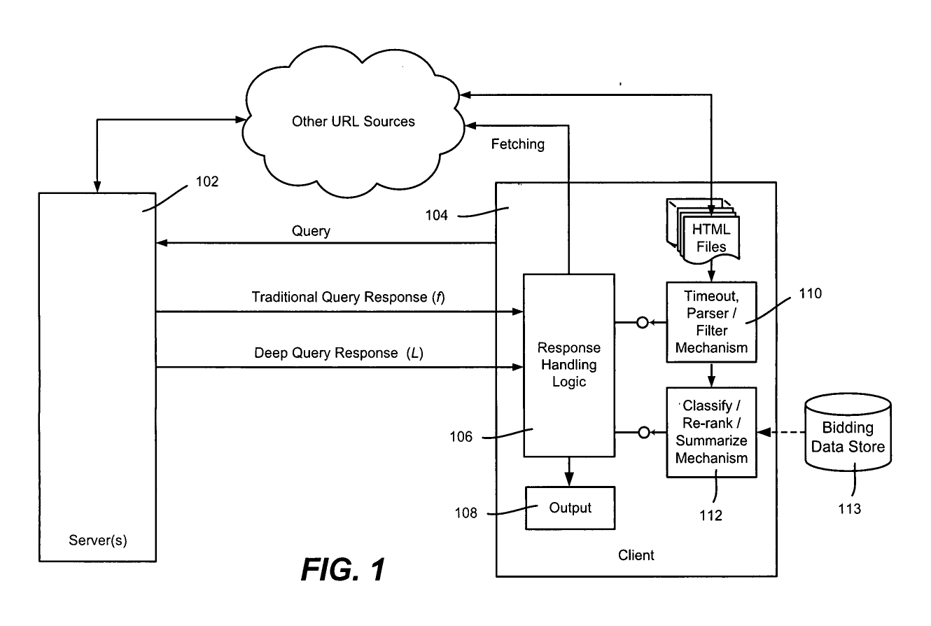

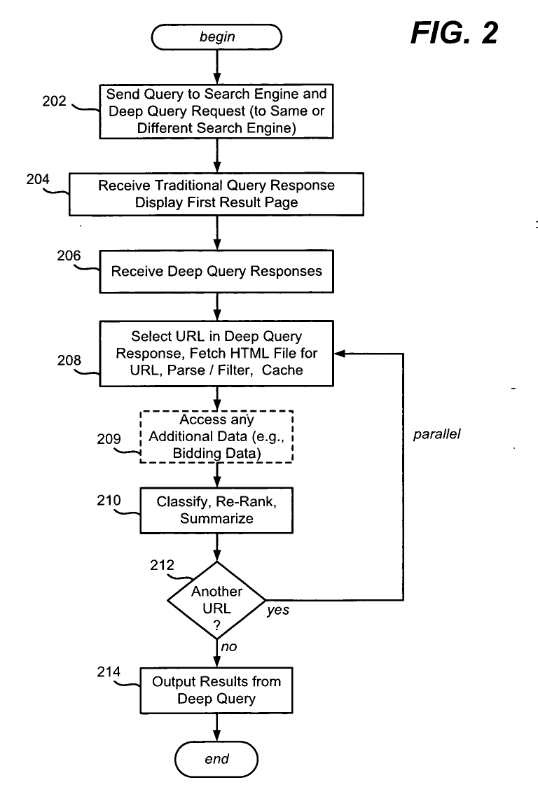

Turning to the drawings, one implementation is exemplified in the block diagram of FIG. 1 and the example steps of FIG. 2, and generally comprises a platform for migrating the relevance computation from a server 102 to a client 104. Beginning at step 202, the client 104 sends (what to the user appears to be a traditional query) a query to the server 102. In one implementation, the query corresponds to a traditional query, as well as to a request for a much larger number of pages. The query may be sent as a dual purpose query to the same search engine, or may be sent as separate queries to a different search engine or even multiple search engines. For example, a toolbar plug-in (e.g., of the browser) can handle the traditional query and deep response query. Note that a search engine may be configured to recognize that a query is a deep query, and thereby operate somewhat differently from normal query processing.

In this example, the server 102 responds with a traditional query response, e.g., by retrieving relevant pages, ranking them, and then returning the top N (e.g., ten) relevant URLs according to the ranking, that is, returning a first result page f. This corresponds to the actions taken by a traditional search engine. Step 204 represents the client receiving this traditional response, and displaying the results, e.g., via response handling logic 106 coupled to an output mechanism 108.

As the server 102 responds with the first result page (or another page) f, a deep query response is also prepared. More particularly, as f is returned, the server 102 (or a different server as set forth above) proceeds delivering a list L of the subsequent (e.g., K minus N) most relevant URLs on record, where K is some (e.g., client and/or server) configurable desired number of URLs to return. In one example implementation, this may be on the order of hundreds. The relevance metric may be simplified to reduce the load on the server; note that at such depth of retrieved results, the accuracy of traditional ranking methods begins to play a less important role. Step 206 of FIG. 2 represents the client receiving this list L.

As represented in FIG. 2 via step 208, the client performs a fetching operation corresponding to some or all of the URLs listed in the list L. For example, the client 104 (e.g., via the response handling logic 106) issues an http:// request for each URL in L, generally in parallel, as a background process. This process may be implemented in numerous ways. One efficient realization that focuses on issuing web requests in parallel via a multithreaded mechanism that maintains a pool of (at least) (K−N) threads, e.g., within the web browser, its toolbar, and/or a plug-in. The task of each thread is to fetch an individual document enlisted in L from the web, such as by using the most plausible web-caching strategy. Threads wake up for each download, and go to sleep after a successful download or timeout. At the same time, the user is likely exploring the links from f or reviewing them.

Each retrieved HTML file lᵢ, is filtered and/or parsed, which in one implementation is performed without retrieving any embedded multimedia. Note that any http:// requests that are not handled by their respective servers within a specific (relatively short) interval are timed-out. Because an HTML file is typically on the order of 10-100 KB, this process is usually completed within a few seconds for most high-speed Internet connections. Moreover, in addition to parsing received files, there is an opportunity to filter out undesirable pages, such as ad aggregators, spam, and so forth, as well as to identify pages having malicious scripts.

Block 110 represents the timeout/parser/filter mechanism, which as can be readily appreciated, may be in one component, or separated in any way. For example, the parser may be part of a browser's software, whereas the filter may be a plug-in that is updated regularly.

Block 112 and step 210 of FIG. 2 represent a client-side mechanism/step to classify, re-rank and summarize the parsed HTML files. For example, this may be handled by a suite of on-line algorithms that continuously process incoming parsed HTML files, e.g., keyword extraction and/or clustering on the text snippets of an HTML page, its title, and so forth may be used in the summarization and/or ranking. A separate bidding database 113 or the like (e.g., a service) may be accessed to determine how to rank e-commerce pages for producing greater revenue. Such a client-side access of additional data is represented by optional step 209.

Still further, personalization concepts as to what topics/keywords in which a user is interested may be used, such as manually input by the user, extracted from emails or instant messages, previous searches/clicks, and so forth. For example, with respect to e-commerce, “brand new” or “new” versus “refurbished” may be part of the user preference data used in ranking if not specifically set forth in the query. Similarly, personalization or other knowledge (e.g., what is particularly popular or newsworthy at the moment) may be used to modify the initial deep search query (such as to append a keyword) or send one or more additional deep search queries with such modifications, e.g., if a user is known to be interested in art, a query such as “Monet” may be typed in by the user and sent in the normal manner, with modified deep search queries such as “Monet” and “paintings”, “Monet” and “exhibits” or even “impressionism” as a substitute keyword sent to obtain additional or different deep search responses for further client-side processing into deep search results.

With respect to query classification, an objective is to first classify the current query and then address it based upon re-ranking and summarizing the content in the list L. In one implementation, the platform provides an API (e.g., as exemplified via the response handling logic 106) for external content analyzer plug-ins so that they may detect and analyze arbitrary classes of web queries. For example, keyword extraction may be used in the classification.

Step 214 represents outputting the deep query results, such as in summarized form as a summary. This may be done in real-time, as the summary gets updated due to newly processed pages (as exemplified in steps 208, 210 and 212 FIG. 2), or may be offered as an option for the user to select when the entire summary or its part is ready. Note that if a user interacts with the traditional search results and/or the deep search results, additional background queries may be sent based upon the interaction to obtain and process additional deep search results.

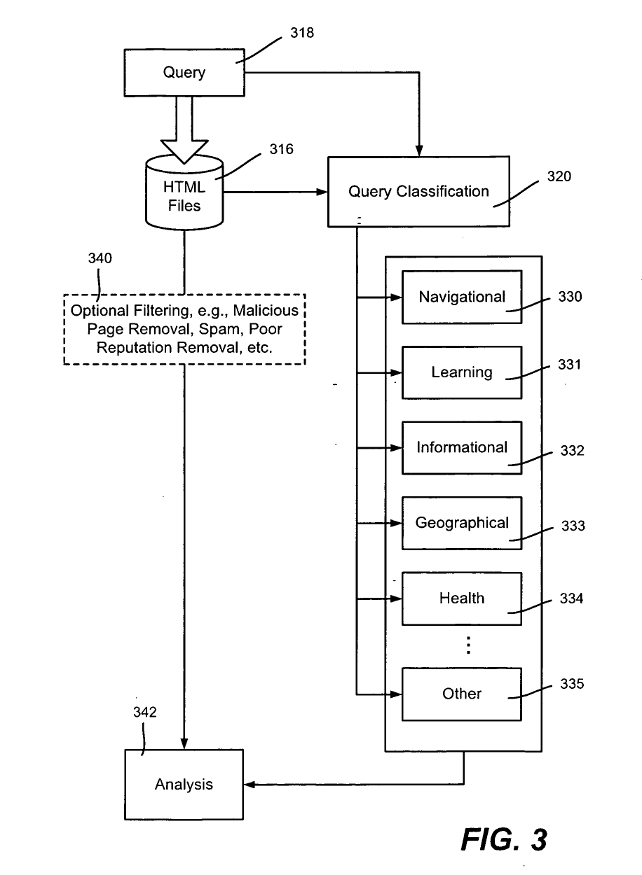

Turning to classification aspects as generally represented in FIG. 3, in one implementation, various types of queries are available to users, whereby, in addition to obtaining HTML files 316, an input query 318 can be classified by a query classifier 320 into a type. A navigational type of query 330 typically represents the inability of the user to know or find the exact URL that leads to a specific Web page, e.g., a query such as “MSN” leads to http://www.msn.com. Generally these queries do not result in revenue, as the user tends to follow a returned link directly to a website.

Another type includes a learning query 331, in which the query reflects a user's desire to learn some knowledge about the query that is available on the web, generally using as few links as possible. One common case when the user wants to learn about a specific detail related to the query Q can also be modeled as learning the full knowledge for a Q′, as data may be conjugated to Q to produce a new query, Q′. To address learning type of queries, Essential Pages may be leverages, as described by A. Swaminathan, C. Mathew, and D. Kirovski, “Essential Pages” MSR technical report, MSR-TR-2008-15, 2008, http://research.microsoft.com/research/pubs/view.aspx?tr_id=1429&0sr=p. Features such as content and keyword clustering may provide benefits.

An informational query 332 is another type, and often corresponds to an e-commerce (e.g., shopping) query in which the query represents the desire of the user to buy a specific product or service, typically at some of the lowest prices and/or from the most trustworthy merchant, (where “trustworthiness” may be vaguely defined by each user or some other service. This type of query is often related to a search engine's revenues. In one classification implementation, this type of query excludes product reviews, comparative shoppers, and the like; a typical objective of it is to provide a list of commercial pages selling the product or service. Additional tools such as recommendation and advertisement engines and connection to a shopping service (such as MSN shopping) may provide further benefits. A geographic type of query 333, which in general is associated with location information geographic services, may be used for similar commercially-related purposes, such as to locate services and other merchants based upon geographic location.

Yet another type of query 334 is directed towards health-related websites and/or services. These queries may or may not correspond to advertisements which can generate revenue, but in any event, are fairly common in web searching. Also shown in FIG. 3 is an “other” type of query, as query classification may be further divided into types, extended in the future, personalized for a user or group of users, and so forth.

Also shown in the left branch of FIG. 3 is the processing of the HTML files. This may include a filtering block 340 or the like, such as to remove duplicate or near duplicate content, remove malicious pages, pages know to correspond to spam, pages with poor reputation, and so forth. The filtering block 340 is shown as dashed to indicate it is generally optional. Note however that in general, only the HTML is available, and thus malicious content embedded in an image, for example, is ordinarily not processed.

An analysis block 342 is also shown in FIG. 3, and generally takes each HTML page, and in conjunction with its query classification type, re-ranks and/or summarizes the deep query pages. Note that the deep query processing may be on the order of seconds in time taken given contemporary client machines, but takes place in parallel with the user's review of the traditional search results which is typically a similar amount of time. However, the deep query results are often far more relevant to the user's query, and may be presented to the user in any way. Indeed, users may get used to inspecting one page while awaiting the deep query results to appear.

Result summarization is an aspect of browsing search results that may benefit from being computed on the client. Sophisticated techniques are possible that take into account web-sites, pages, personalization, and so forth. Presentation of the summary on a user interface may be noninvasive, simple and intuitive. For example, the user interface output may handle the information processed by the platform in real-time so as to continuously update the presented summary to the user.

Personalization may be facilitated, e.g., due to the large collection of Web-pages that are available to the user, the user interface may, for example, present a “web-page show” such that by clicking on a “play” button or the like, the user starts a session of automatic visits to a group of pages from L in a slide-show mode, with timing between visiting the next web sites being adjustable by the user at run-time. For users that want to reach deeper into links provided by the server, a “more” button or the like may fetch the next consecutive group of relevant URLs from the search engine, start their retrieval, and conclude with the content analysis of newly downloaded pages, effectively enlarging the cardinality of L in a seamless fashion.

The above technology simplifies the server technology to the point where a search engine may quickly return only the top-N (e.g., ten) URLs and ignore the ranking and relevance accuracy of the subsequent top K−N URLs most related to the query, because the remainder of the query analysis is performed on the client. This likely reduces the cost associated with running a server farm dedicated to a search engine while continuously improving user satisfaction. In addition, a simple caching scenario on the server also may reduce the effort done by the clients and web-servers hosting content. In such an alternative/extension, cached summaries for common queries may be delivered to clients directly from the query-cache server or another intermediary, or the client itself in a peer-to-peer network, for example. If client search results are returned to the query-cache server for serving to others, a filtering mechanism, such as a majority or other voting scheme (e.g., over random selections) may be used to ensure that unusual or malicious client-generated results are not served to others.

As can be seen, a plug-in or other code within a browser seamlessly downloads related HTML pages, and based upon their text content, creates a summary to present it to the user. Because significantly more processing time is available at the client, the deep fetching and analysis (block 342) tends to create significantly a better and more meaningful experience for users. The platform may cache summaries, and users may use such summaries from a global cache.

Further described is a methodology that can be used by a search engine to avoid being intercepted by the above-described mechanism, that is, to prevent search engines from disclosing query data to plug-ins or the like. In one example implementation, by connecting to the user via an SSL session (https://), the search engine prevents characters typed into its forms from being intercepted by a toolbar or plug-in by some browsers. Although expensive at the server, this technique prevents the mechanism from disclosing sensitive data.

### Exemplary Operating Environment

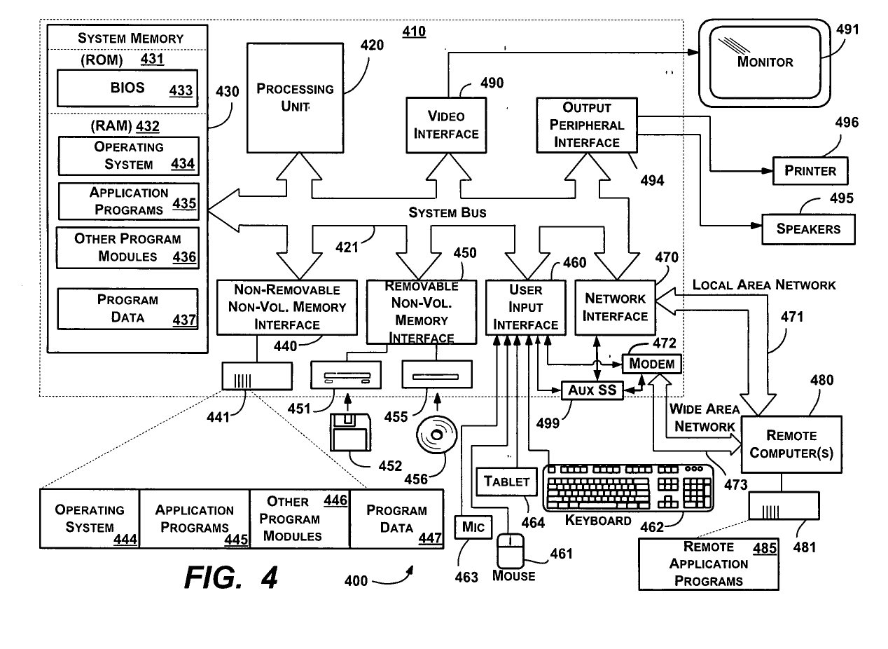

FIG. 4 illustrates an example of a suitable computing and networking environment 400 on which the examples of FIGS. 1-3 may be implemented. The computing system environment 400 is only one example of a suitable computing environment and is not intended to suggest any limitation as to the scope of use or functionality of the invention. Neither should the computing environment 400 be interpreted as having any dependency or requirement relating to any one or combination of components illustrated in the exemplary operating environment 400.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 4, an exemplary system for implementing various aspects of the invention may include a general purpose computing device in the form of a computer 410. Components of the computer 410 may include, but are not limited to, a processing unit 420, a system memory 430, and a system bus 421 that couples various system components including the system memory to the processing unit 420. The system bus 421 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 410 typically includes a variety of computer-readable media. Computer-readable media can be any available media that can be accessed by the computer 410 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 410. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 430 includes computer storage media in the form of volatile and/or nonvolatile memory such as read only memory (ROM) 431 and random access memory (RAM) 432. A basic input/output system 433 (BIOS), containing the basic routines that help to transfer information between elements within computer 410, such as during start-up, is typically stored in ROM 431. RAM 432 typically contains data and/or program modules that are immediately accessible to and/or presently being operated on by processing unit 420. By way of example, and not limitation, FIG. 4 illustrates operating system 434, application programs 435, other program modules 436 and program data 437.

The computer 410 may also include other removable/non-removable, volatile/nonvolatile computer storage media. By way of example only, FIG. 4 illustrates a hard disk drive 441 that reads from or writes to non-removable, nonvolatile magnetic media, a magnetic disk drive 451 that reads from or writes to a removable, nonvolatile magnetic disk 452, and an optical disk drive 455 that reads from or writes to a removable, nonvolatile optical disk 456 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 441 is typically connected to the system bus 421 through a non-removable memory interface such as interface 440, and magnetic disk drive 451 and optical disk drive 455 are typically connected to the system bus 421 by a removable memory interface, such as interface 450.

The drives and their associated computer storage media, described above and illustrated in FIG. 4, provide storage of computer-readable instructions, data structures, program modules and other data for the computer 410. In FIG. 4, for example, hard disk drive 441 is illustrated as storing operating system 444, application programs 445, other program modules 446 and program data 447. Note that these components can either be the same as or different from operating system 434, application programs 435, other program modules 436, and program data 437. Operating system 444, application programs 445, other program modules 446, and program data 447 are given different numbers herein to illustrate that, at a minimum, they are different copies. A user may enter commands and information into the computer 410 through input devices such as a tablet, or electronic digitizer, 464, a microphone 463, a keyboard 462 and pointing device 461, commonly referred to as mouse, trackball or touch pad. Other input devices not shown in FIG. 4 may include a joystick, game pad, satellite dish, scanner, or the like. These and other input devices are often connected to the processing unit 420 through a user input interface 460 that is coupled to the system bus, but may be connected by other interface and bus structures, such as a parallel port, game port or a universal serial bus (USB). A monitor 491 or other type of display device is also connected to the system bus 421 via an interface, such as a video interface 490. The monitor 491 may also be integrated with a touch-screen panel or the like. Note that the monitor and/or touch screen panel can be physically coupled to a housing in which the computing device 410 is incorporated, such as in a tablet-type personal computer. In addition, computers such as the computing device 410 may also include other peripheral output devices such as speakers 495 and printer 496, which may be connected through an output peripheral interface 494 or the like.

The computer 410 may operate in a networked environment using logical connections to one or more remote computers, such as a remote computer 480. The remote computer 480 may be a personal computer, a server, a router, a network PC, a peer device or other common network node, and typically includes many or all of the elements described above relative to the computer 410, although only a memory storage device 481 has been illustrated in FIG. 4. The logical connections depicted in FIG. 4 include one or more local area networks (LAN) 471 and one or more wide area networks (WAN) 473, but may also include other networks. Such networking environments are commonplace in offices, enterprise-wide computer networks, intranets and the Internet.

When used in a LAN networking environment, the computer 410 is connected to the LAN 471 through a network interface or adapter 470. When used in a WAN networking environment, the computer 410 typically includes a modem 472 or other means for establishing communications over the WAN 473, such as the Internet. The modem 472, which may be internal or external, may be connected to the system bus 421 via the user input interface 460 or other appropriate mechanism. A wireless networking component 474 such as comprising an interface and antenna may be coupled through a suitable device such as an access point or peer computer to a WAN or LAN. In a networked environment, program modules depicted relative to the computer 410, or portions thereof, may be stored in the remote memory storage device. By way of example, and not limitation, FIG. 4 illustrates remote application programs 485 as residing on memory device 481. It may be appreciated that the network connections shown are exemplary and other means of establishing a communications link between the computers may be used.

An auxiliary subsystem 499 (e.g., for auxiliary display of content) may be connected via the user interface 460 to allow data such as program content, system status and event notifications to be provided to the user, even if the main portions of the computer system are in a low power state. The auxiliary subsystem 499 may be connected to the modem 472 and/or network interface 470 to allow communication between these systems while the main processing unit 420 is in a low power state.

### Conclusion

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents failing within the spirit and scope of the invention.

What is claimed is:

1. In a computing environment, a method comprising, providing a query from a client computer to a search engine, receiving a deep query response in response to the query, obtaining content corresponding to the deep query response, and processing the content on the client computer to generate deep search results.

2. The method of claim 1 wherein obtaining the content comprises fetching files identified in the deep query response, and wherein processing the search results comprises parsing the content, including using at least some text in the files to generate the deep search results.

3. The method of claim 1 further comprising, receiving a traditional search result at the client computer, and outputting information corresponding to the traditional search result while processing the content to generate the deep search results.

4. The method of claim 1 wherein processing the content on the client computer to generate the deep search results comprises summarizing data or ranking data based upon the content, or both summarizing and ranking data based upon the content.

5. The method of claim 1 wherein processing the content on the client computer to generate the deep search results comprises classifying the query into a type, and using the type in generating at least part of the deep search results.

6. The method of claim 1 further comprising, accessing bidding data, and wherein processing the content on the client computer to generate the deep search results comprises using the bidding data in generating at least part of the deep search results.

7. The method of claim 1 further comprising, caching at least some of the deep search results for access by another client.

8. The method of claim 1 further comprising, filtering at least some of the deep search results cached from the client before providing access to another client.

9. In a computing environment, a system comprising, a client component that obtains a traditional query response and a deep query response, the client configured to output first information corresponding to the traditional query response, and further comprising, client-side logic that obtains content corresponding to the deep query response, processes the content to generate deep search results, and outputs second information corresponding to the deep query response.

10. The system of claim 9 wherein the deep query response comprises a plurality of URLs, wherein the content corresponding to the deep query response comprises HTML files, and where the logic includes a mechanism that parses the HTML to process text content within the HTML.

11. The system of claim 9 wherein the client-side logic that obtains the content corresponding to the deep query response comprises a multithreaded fetching mechanism.

12. The system of claim 9 wherein the second information comprises a set of ranked URLs, the ranking based at least in part on the text content of the parsed files, or based at least in part on accessing revenue-related information, or based at least in part on both the text content of the parsed files and on accessing revenue-related information.

13. The system of claim 9 further comprising a filtering mechanism that decides whether to discard each of the files.

14. The system of claim 9 wherein the deep query response is obtained from one search engine that is different from another search engine that provides the traditional query response, or wherein the deep query response is obtained based upon one query that is different from another query used to obtain the traditional query response, or wherein the deep query response is both obtained from one search engine that is different from another search engine that provides the traditional query response and is obtained based upon one query that is different from another query used to obtain the traditional query response.

15. The system of claim 9 wherein the logic includes a query classification mechanism that classifies queries into types, the types including a navigational type, a learning type, an informational type, a geographical type or a health type, or any combination of a navigational type, a learning type, an informational type, a geographical type or a health type.

16. The system of claim 9 wherein the logic includes means for re-ranking the results, or means for summarizing the results, or both means for re-ranking the results and means for summarizing the results.

17. One or more computer-readable media having computer-executable instructions, which when executed perform steps, comprising:
outputting first information corresponding to a traditional query response based upon one or more URLs;
obtaining a deep query response comprising URLs in addition to those corresponding to the traditional query response;
fetching files based upon the URLs of the deep query response;
parsing the files to analyze content therein;
generating deep search results based upon the content; and
outputting second information corresponding to the deep search results.

18. The one or more computer-readable media of claim 17 wherein generating the deep search results further comprises accessing revenue-related data and using the revenue-related data to rank at least some of the second information.

19. The one or more computer-readable media of claim 17 wherein the traditional query response and deep query response correspond to a query set comprising at least one query, and wherein generating the deep search results further comprises classifying the query set into at least one type.

20. The one or more computer-readable media of claim 17 wherein at least some of the files are fetched substantially in parallel, and wherein generating the deep search results comprises updating the second information as each file is received and processed.
